(19) United States
(12) Patent Application Publication
(10) Pub. No.: US 2008/0028021 A1
(43) Pub. Date: Jan. 31, 2008

(54) Customer relationship management system and method

(76) Inventors: John Roberts, San Jose, CA (US); Jacob Taylor, Santa Clara, CA (US); Clinton Oram, San Mateo, CA (US); Andrew Dreisch, San Jose, CA (US); Majed Itani, San Jose, CA (US); Wayne Pan, Milpitas, CA (US); Roger Smith, Apex, NC (US); Julian Ostrow, Cupertino, CA (US); Chris Nojima, San Francisco, CA (US)

Correspondence Address: DLA PIPER US LLP, 2000 UNIVERSITY AVENUE, E. PALO ALTO, CA, 94303-2248, US

(21) Appl. No.: 11/717,503

(22) Filed: Mar. 12, 2007

Related U.S. Application Data
(60) Provisional application No. 60/781,511, filed on Mar. 10, 2006.

(51) Int. Cl. G06F 15/16

(52) U.S. Cl. 709/203

(57) ABSTRACT

A software-based customer relationship management system and method.

### PRIORITY CLAIM

This application claims priority under 35 USC 119(e) to U.S. Provisional Patent Application Ser. No. 60/781,511 filed on Mar. 10, 2006 and entitled “Customer Relationship Management System and Method” which is incorporated herein by reference.

### APPENDIX

Appendix A contains 7 slides of a PowerPoint presentation that describes the integration of SugarNetwork access into a CRM system.

### FIELD OF THE INVENTION

The invention relates generally to a customer relationship management system and method and in particular to a software-based system and method for providing customer relationship management.

### BACKGROUND OF THE INVENTION

Customer relationship management (CRM) systems and solutions are well known. For example, typical known CRM systems include Microsoft® CRM, SalesForce, a CRM product provided by SalesForce.com, Netsuite CRM, and SAP Business One CRM. However, conventional CRM systems have significant limitations that include a lack of flexibility, high costs, and a closed-source structure which is embedded into the traditional product offerings. These limitations have led to a failure rate of over 70% with traditional CRM implementations. Thus, it is desirable to provide a customer relationship management system and method that overcomes these limitations of typical CRM systems and it is to this end that the invention is directed.

### BRIEF DESCRIPTION OF THE DRAWINGS

FIG. 1A is a diagram illustrating a customer relationship management system that incorporates the various features of the invention;

FIG. 1B illustrates more details of the customer relationship management system that incorporates the various features of the invention;

FIG. 2 is a diagram illustrating an example of the user interface of the system in FIG. 1;

FIG. 3 illustrates an example of the dashboard user interface including the pipeline by sales stage chart of the CRM system;

FIG. 4 illustrates an example of the dashboard user interface during the drag/drop process;

FIGS. 5 and 6 show the dashboard user interface when the drag/drop process has been completed;

FIG. 7 illustrates a typical option menu;

FIG. 8 illustrates the same menu as FIG. 7 with contextual menu items;

FIG. 9 illustrates more details of the contextual menu items;

FIG. 10 illustrates an example of the data record in the CRM system that causes the contextual menu items in FIG. 8 to be generated;

FIG. 11 illustrates an example of the integration of email items with the CRM system;

FIG. 12 illustrates an example of a user interface for configuring inbound email;

FIG. 13 illustrates an example of a user interface for configuring outbound email;

FIG. 14 is the pseudocode for the inbound email auto-configuration process in accordance with the invention;

FIG. 15 illustrates an example of a user interface for providing ecommerce software within open source repository software;

FIG. 16 illustrates an example of a user interface containing the shopping cart;

FIG. 17 an example of a user interface containing a check-out; and

FIG. 18 an example of a user interface for rating software.

### DETAILED DESCRIPTION OF AN EXEMPLARY EMBODIMENT

The invention is particularly applicable to an open source customer relationship management software system and it is in this context that the invention will be described. It will be appreciated, however, that the algorithms, data structures, processes and modules in accordance with the invention has greater utility since these modules and inventive aspects disclosed herein can be equally applied to other non-open source CRM systems, as well as other business software application systems as well as other database software systems. For purposes of illustration, the described system is an implementation in a customer relationship management (CRM) and groupware system although the inventive methods apply across multiple systems. In the example, the CRM and groupware system is SugarCRM Inc.'s Sugar Enterprise 4.2.

The system may be implemented in a preferred embodiment using a base class known as SugarBean, and a data retrieval API. The base class has methods for building list queries, saving, and retrieving individual items. Each specific type of data creates a subclass of this base class. In a preferred embodiment of the invention, the base class is called SugarBean. There is at least one subclass of SugarBean for each module. SugarBeans also are used for creating database tables, cleaning out database tables, loading records, loading lists, saving records, and maintaining relationships. One example of a SugarBean subclass is Contact. Contact is a simple object that fills in some member variables on the SugarBean and leverages SugarBean for much of its logic. Security for instance, is automatically created for Contact. Another example of a SugarBean subclass is Users which is a module that is security related and should not have row level security applied to them. For this reason these modules have the bypass flag set to skip adding the right join for verifying security. The SugarCRM Sugar Professional system is a web based system with many concurrent users. Since this program contains critical data to the users, it is imperative that they have quick access to the system and their data. The most frequent activity in the program is to look at existing data.

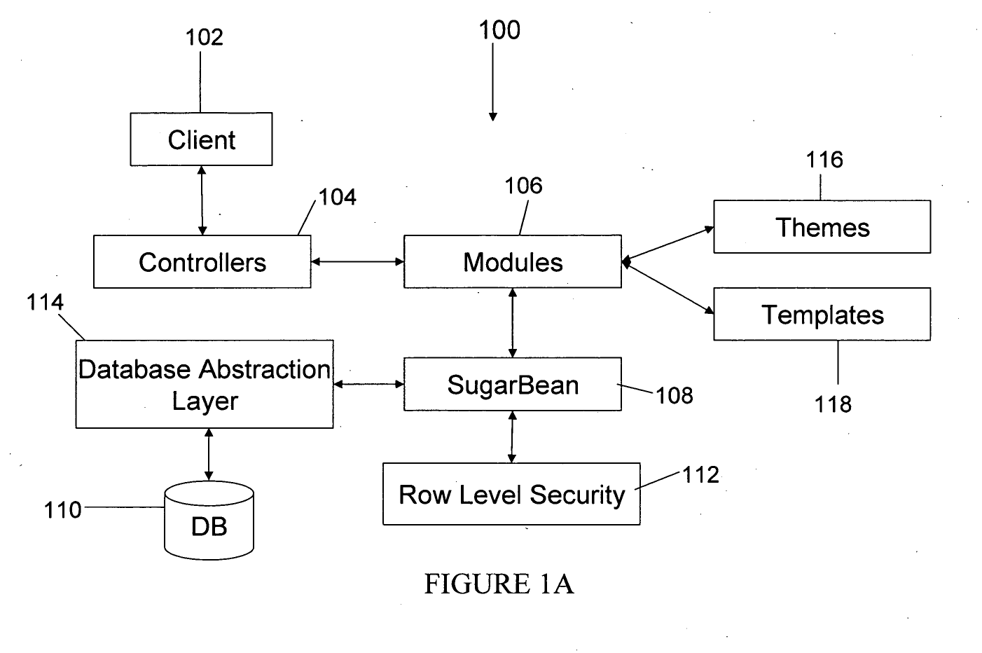

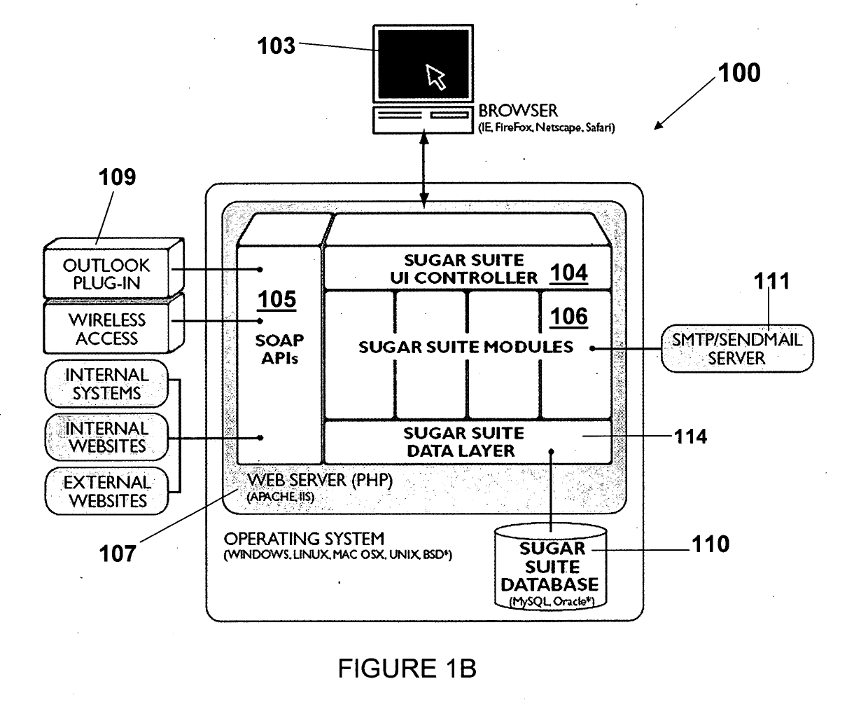

FIG. 1A is a diagram illustrating a customer relationship management (CRM) system 100 that is an example of a software-based business software application in accordance with the invention. In a preferred embodiment, the system 100 in accordance with the invention is implemented as a software system and the elements shown in FIG. 1 are thus implemented as a plurality of lines of computer code that may be executed by a processor of a computer system, such as a server computer wherein the various lines of computer code are stored in a memory associated with the computer system and the system interfaces with a database 110. The system may have one or more clients 102, such as a browser application executed on a typical computing device (a browser client session), that accesses the system over a communications network 103 such as the Internet, a cellular network, a wireless network and the like. The computing devices may include a laptop, table or desktop computer system, a PDA, a mobile phone, a portable wireless email device and the like. The client 102 interactions go through a set of one or more controllers 104. The controllers are the entry-point into the system and take care of things like session tracking, session security and end user authentication. The controllers also take care of the work to prepare the screen or the wrapper for the content and determine which module of the application the user is trying to access and get the requested module to process the request. The system thus has one or more modules 106 that are components of application functionality and provide certain functionality. The modules 106 of the exemplary CRM system shown in FIG. 1 may include, by way of example, a portal module, a calendar module, an activities module, a contacts module, an accounts module, a leads module, an opportunities module, a quotes module, a products module, a cases module, a bug tracker module, a documents module, an emails module, a campaigns module, a project module, an RSS module, a forecasts module, a reports module and a dashboard module. In accordance with the invention, the system may include different, more or fewer modules and the systems with those other combination of modules are within the scope of the invention. Each of these modules provides a different functionality to the system so that, for example, the calendar module provides a calendaring functionality to the CRM system that is instantiated with the system. The system may also include an administration module that handles the typical administrative functions of the system. Each module contains a subclass of a SugarBean base object 108 and each module references the SugarBean to retrieve the data from the database 110 required for display.

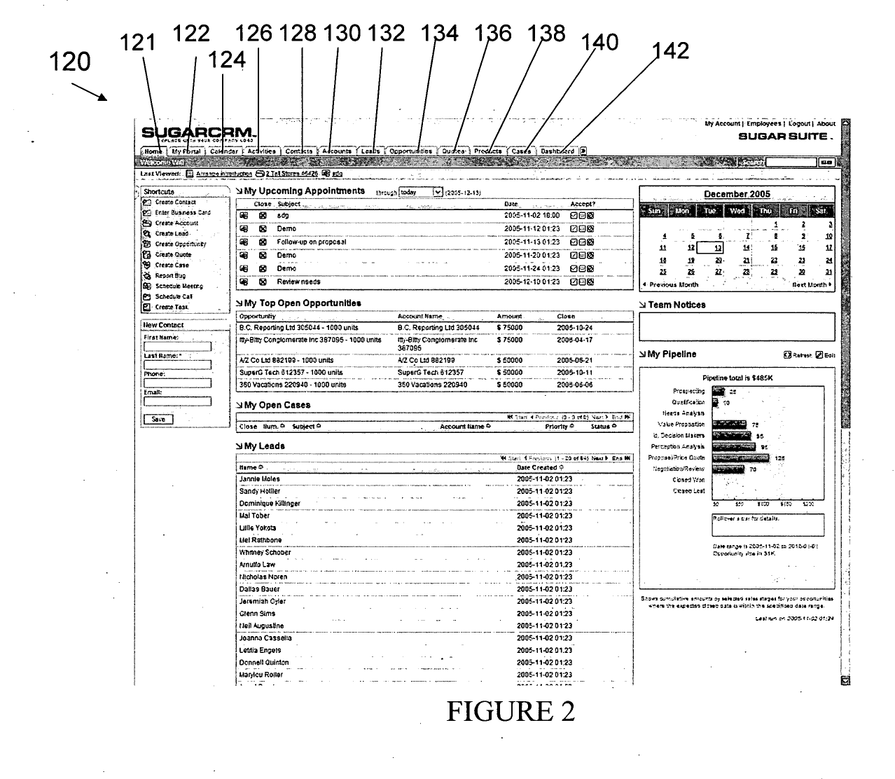

FIG. 2 is a diagram illustrating an example of the user interface 120 of the system in FIG. 1. The user interface may include a home tab 121 (that is selected in FIG. 2A) that provides a general overview of Cases, Opportunities, Appointments, Leads, Tasks, Calendar, Team Notices, and Pipeline. The home tab also includes shortcuts to enter various different types of data, and a quick form for new contacts. The home tab also provides a quick overview of what customer tasks and activities that the user needs to focus on today. The portal module (selected using a “My portal” tab 122), contains a series of shortcuts which can link to any web site chosen by the user that may include e-mail, forums, or any other web-based application, allowing the system to become a single user interface for multiple applications. The calendar module may be selected by a calendar tab 124 and allows the user to view scheduled activities (by day, week, month or year), such as meetings, tasks, and calls. The system also allows the user to share his/her calendar with coworkers which is a powerful tool for coordinating the daily activities. The activities module is selected using an activities tab 126 and allows the user to create or update scheduled activities, or to search for existing activities. By managing Activities within the context of an Account, Contact, Lead, Opportunity, or Case, the system allows the user to manage the myriad of calls, meetings, notes, emails and tasks that the user needs to track in order to get the job done. The tasks are for tracking any action that needs to be managed to completion by a due date, the notes allow the user to capture note information as well as upload file attachments, the calls allow the user to track phone calls with leads and customers, meetings are like calls, but also allow the user to track the location of the meeting and emails allow the user to archive sent or received email messages.

The contacts module is accessed by a contacts tab 128 and allows the user to view a paginated contact list, or search for a contact. The user can click on a specific contact to zoom in on the detailed contact record and, from a specific contact record, the user may link to the related account, or leads, opportunities, cases, or direct reports (related contacts). Within the system, contacts are the people with whom the organization does business. As with accounts, the system allows the user to track a variety of contact information such as title, email address, and other data. Contacts are usually linked to an Account, although this is not required. The accounts module may be accessed using an accounts tab 130 and the user may view a paginated account list, or search for an account. The user can click on a specific account to zoom in on the detailed account record and, from a specific account record, the user may link to related contacts, activities, leads, opportunities, cases, or member organizations. Accounts are the companies with which the organization does business and the system allows the user to track a variety of information about an account including web site, main address, number of employees and other data. Business subsidiaries can be linked to parent businesses in order to show relationships between accounts.

The leads module may be accessed by a leads tab 132 that permits the user to view a paginated list of leads, or search for a specific lead. The user can click on an individual lead to zoom in on the lead information record and, from that detailed lead record, the user can link to all related activities, and see the activity history for the lead. Leads are the people or companies with whom the organization might do business in the future. Designed to track that first point of interaction with a potential customer, leads are usually the hand off between the marketing department and the sales department. Not to be confused with a contact or account, leads can often contain incomplete or inaccurate information whereas contacts and accounts stored in Sugar Professional are core to many business processes that require accurate data. Leads are typically fed into the Sugar Professional system automatically from your website, trade show lists or other methods. However, the user can also directly enter leads into Sugar Professional manually.

The opportunities module is accessed by an opportunities tab 134 and permits the user to view a paginated list of opportunities, or search for a specific opportunity. The user can click on an individual opportunity to zoom in on the opportunity information record and, from that detailed opportunity record, the user can link to all related activities, see the activity history for the opportunity, and link to related leads and contacts. Opportunities track the process of selling a good or service to a potential customer. Once a selling process has commenced with a lead, a lead should be converted into a contact and possibly also an account. Opportunities help the user manage the selling process by tracking attributes such as sales stages, probability of close, deal amount and other information. The quotes module may be accessed by a quotes tab 136 and permits the user to view a paginated list of customer quotes, or search for a specific quote. The user can click on an individual quote to zoom in on the detailed quote information. A quote is formed by referencing product and pricing from a catalog of products you may create. A presentation quality Portable Document Format (PDF) representation of the quote may be created to fax or email to a client. Quotes may be associated with Accounts, Contacts, or Opportunities.

The products module may be accessed by a products tab 138 and permits the user to view a paginated list of products, or search for a specific product. The user can click on an individual product to zoom in on the detailed product information. A product is used when assembling a customer quote. The cases module may be accessed using a cases tab 140 and may permit the user to view a paginated list of cases, or search for a specific case. The user can click on an individual case to zoom in on the case information record and, from that detailed case record, the user can link to all related activities, see the activity history for the case, and link to related contacts. The cases are the handoff between the sales department and the customer support department and help customer support representatives manage support problems or inquiries to completion by tracking information for each case such as its status and priority, the user assigned, as well as a full trail of all related open and completed activities. A dashboard (such as that shown for example in FIG. 2B) module may be accessed using a dashboard tab 142 and permits the user to view a dashboard of the information in the CRM system.

The documents module may show the user a list of documents that the user can download. The user can also upload documents, assign publish and expiration dates, and specify which users can access them. The email module allows the user to write and send emails and to create Email Templates that can be used with email-based marketing campaigns. The user can also save drafts and archive emails. The campaigns module helps the user implement and track marketing campaigns wherein the campaigns may be telemarketing, mail or email based. For each Campaign, the user can create the Prospects list from the Contacts or Leads or outside file sources. The projects module helps the user manage tasks related to specific projects. Tasks can be assigned to different users and assigned estimated hours of effort and, as tasks are in progress and completed, users can update the information for each task. The RSS module permits the user to view the latest headlines provided by your favorite Really Simple Syndication (RSS) feeds. These feeds provide news or other web content that is distributed or syndicated by web sites which publish their content in this manner. The system has hundreds of RSS feeds available as supplied, and others may easily be added.

The forecasts module shows the user his/her committed forecast history and current opportunities. For managers, the user can view your team's rolled up forecasts. The reports module shows the user a list of saved custom reports not yet published, as well as a list of Published Reports. Saved reports may be viewed, deleted or published, and published reports may be viewed, deleted or un-published. Clicking on the name of a report zooms to the detailed definition of the report criteria (fields to be displayed, and filter settings) for that report, permitting the user to alter the criteria, and re-submit the report query. Finally, the dashboard module displays a graphical dashboard of the user's Opportunity Pipeline by Sales Stage, Opportunities by Lead Source by Outcome, Pipeline by Month by Outcome, and Opportunities by Lead Source.

Returning to FIG. 1A, the system also includes the database 110 that contains the data of the system and a security module 112 that implements the security methods to control access to the data in the database 110. The system may also include a database abstraction layer 114 that is coupled between the database 110 and the SugarBean object 108 in order to be an interface between the database 110 and the SugarBean object 108. The SugarBean object 108 provides the base logic required for retrieving and making available information from the database and each module creates subclasses of SugarBean to provide module specific details. During the process of retrieving data from the database, the SugarBean 108 makes calls that populate the row level security information into the SQL that retrieves the data.

Once the data is retrieved from the SugarBean object 108, the module uses a template mechanism 118 and a theme 116 to produce the requested presentation for the user. The template mechanism reformats the data from the database 110 into a particular form while the theme adjusts the user interface according to the user's preferences. If, for instance, the user requests an HTML presentation of the detail view of the contact module for a specified contact, here is the flow of what happens. The user hits the controller named index.php. It handles most of the logic for the main application. The index controller loads the current user, verifies authentication and session information, loads the language for the user and produces some of the user interface shell. The index controller then calls the contact module and request the detail view for the specified contact. The contact module retrieves the SugarBean for the requested contact. The SugarBean verifies row level security at this point. If the record is not retrieved successfully, then the process aborts and the user is not allowed to view the data for the record. If the retrieve process succeeds then it uses the XTemplate mechanism and the code for the current user's theme to create the user interface for presentation. The resulting user interface is sent back to the client that requested it.

FIG. 1B illustrates more details of the customer relationship management system 100 that incorporates the various features of the invention. Like elements shown in FIGS. 1A and 1B have like reference numerals. The system may interface with a typical browser application 103 (being executed by a computing device) that can access the system 100 over the web. For example, the examples of the user interface below are web-based views generated by the system and displayed on a browser application. The system may further comprise an application programming interface (APIs) portion 105, that may preferably use the well known simple object access protocol (SOAP), to interface with other existing system and applications. For example, the APIs may be used to interface to an email plug-in 109, such as an Outlook plug-in, that permits the system 100 to interact with the email program. As another example, the system may interface with existing web services, such as look-up functions and the like that are described in more detail below. As shown, the system 100 is preferably implemented on a web server application 107 (that may preferably be the well known Apache web server that includes IIS functionality) that generates dynamic web pages (PHP). The web server and the other elements of the system may be implemented as software running on one or more servers wherein the servers may use various different operating system as shown in FIG. 1B. The system 100 may also interface with an SMTP/sendmail server 111.

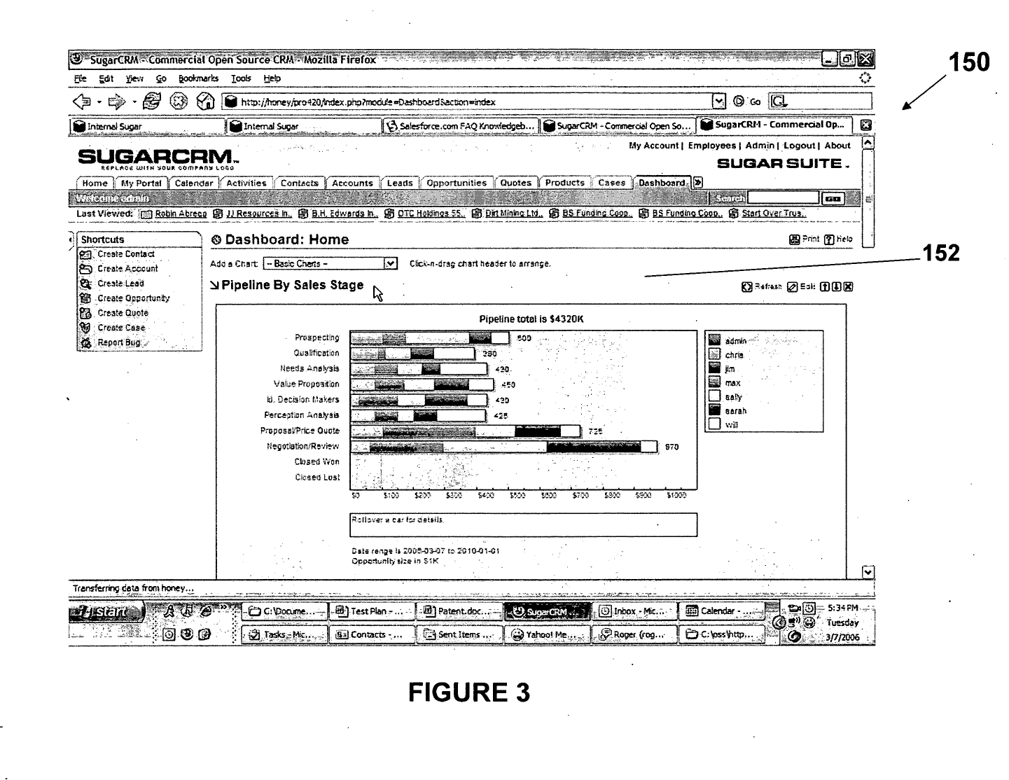

FIG. 3 illustrates an example of a user interface 150 for a pipeline by sales stage chart of the CRM system. The system 100 includes a drag-drop metaphor in the Web-based CRM context. This capability provides for the quick and convenient rearranging of the layout of the user interface, CRM business tools, in particular Charts on Dashboards of the system. Other CRM business objects exposed through the application will be implemented using similar mechanisms, such as the Home screen where key business data is presented. Thus, FIG. 3 illustrates a Pipeline by Sales Stage chart 152 on a configurable dashboard prior to any drag-drop process so that the chart occupies the top position of multiple objects. The drag-drop process permits the user to quickly and easily reconfigure the user interface of the CRM system that is not possible with other CRM systems. Thus, the system can be easily reconfigured for each individual user.

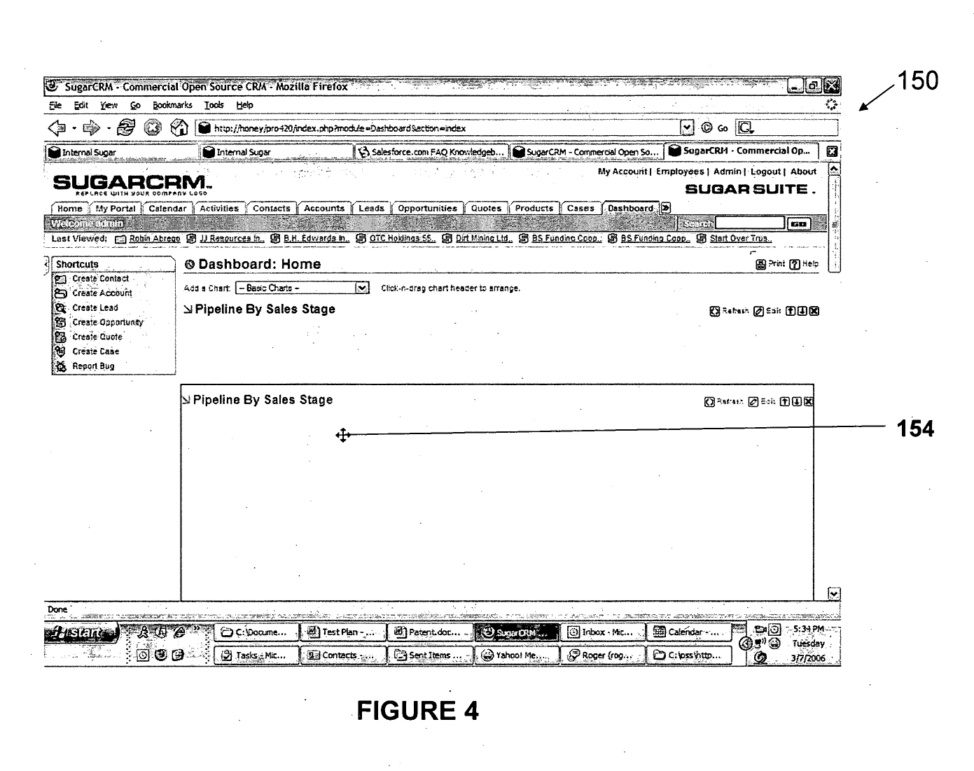

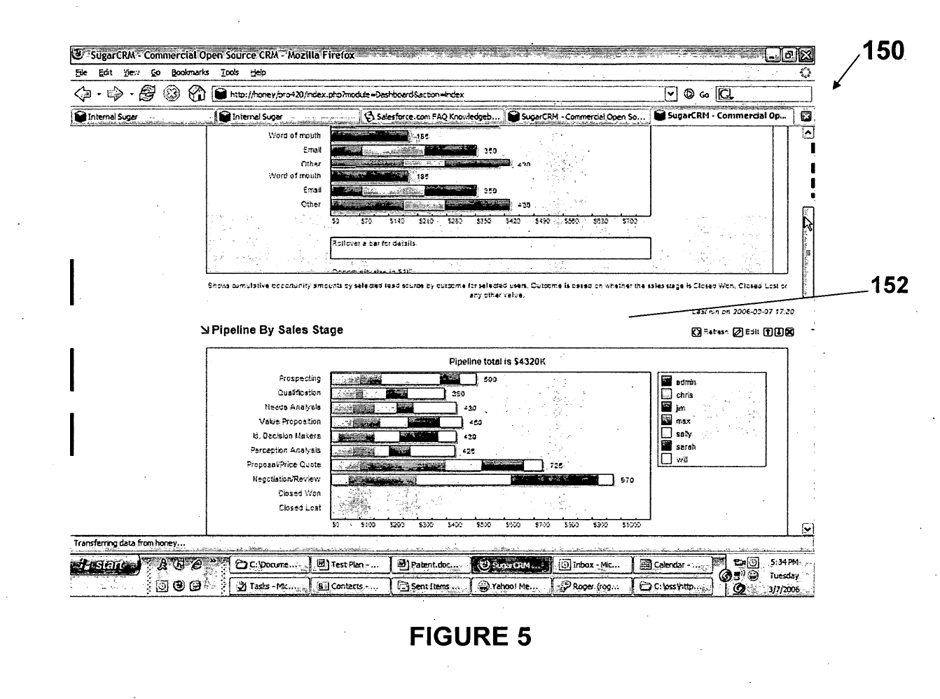

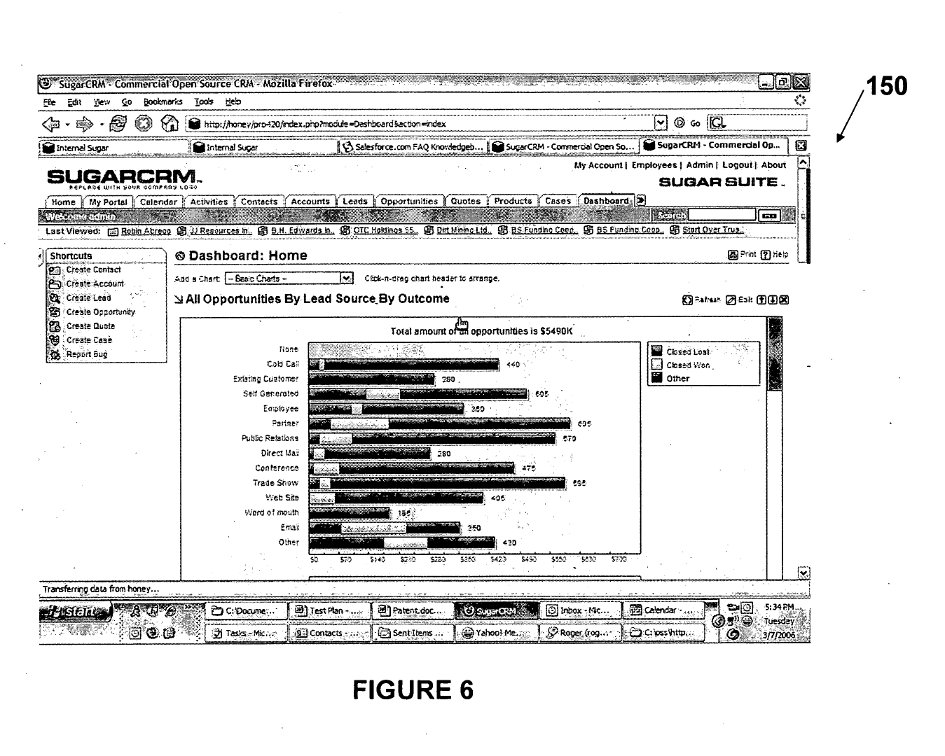

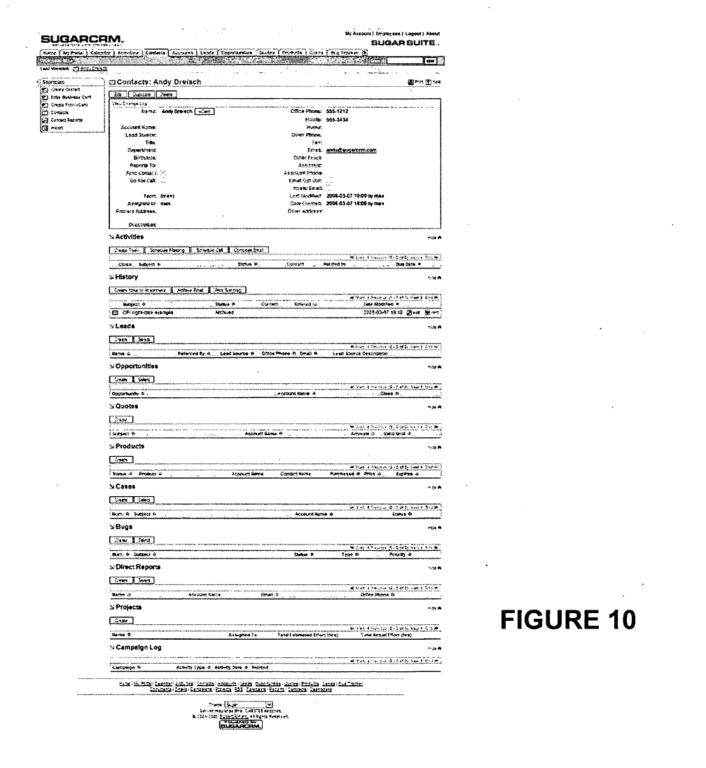

FIG. 4 illustrates an example of the user interface 150 during the drag/drop process wherein the cursor is now a positioning indicator 154 that permits the user to reposition the pipeline by sales stage chart using a drag-drop methodology. When the chart is positioned correctly, the user can release the mouse, ending the drag-drop operation and placing the chart into its new position (See FIG. 5) and shuffling other charts accordingly. As shown in FIG. 6, the top position in the dashboard is now occupied by another chart as part of the reshuffling that occurs in response to the drag-drop procedure. The new layout is saved for the current user and is automatically used on future renderings of the dashboard tab. While the initial implementation of this functionality allows rearranging of graphs on the dashboard, the functionality will also work for rearranging any objects visible on the screen. Example of objects that can be arranged using this approach include sub-panels (In FIG. 10, this is every section below the top section: Activities, History, Leads, . . . ), Home Screen Layout (FIG. 2 every section in the main portion of the screen: My Upcoming Appointments, My Top Open Opportunities, . . . . Team Notices, My Pipeline, the Calendar. Similar techniques are being integrated into the editor for our system to allow easier customization of the layout of the user interface (including all fields on all screens). Now, a method for integrating web services into contextual menu items for the CRM system will be described in more detail.

The system includes the email plug-in as shown in FIG. 1B. The system adjusts the user's navigation in the email program, Microsoft Outlook in this example although this methodology can be applied to any email program, plug-in, or external program, is customized/adjusted by the existence (or absence) of data in the database 110 (See FIGS. 1A and 1B) of the CRM system that are obtained via web service functions. For example, a search for accounts by email web service or archive an email web service may be provided, each of which is now described in more detail.

Search for Accounts by Email

The outlook programming interface (OPI) can search for Accounts by two methods. The first is by name and the second is by relationship to a Contact. The web service calls (using SOAP) for the second method is now described.

/**
* Given a list of modules to search and a search string, return the id,
module_name, along with the fields
* as specified in the $query_array
*
* @param string $user_name - username of the Sugar User
* @param string $password - password of the Sugar User
* @param string $search_string - string to search
* @param string[ ] $modules - array of modules to query
* @param int $offset - a specified offset in the query
* @param int $max_results - max number of records to return
* @return get_entry_list_result - id, module_name, and list of fields
from each record
*/
function search_by_module($user_name, $password, $search_string,
$modules, $offset, $max_results)

1) Search_by_Module( )

If this returns a Contact that contact will have a little±toggle to the lext of the name which will indicate there is associated data with this contact. When the user clicks the +image OPI then makes a call to:

/**
* Return a list of modules related to the specifed contact record
*
* This function does not require a session be created first.
*
* @param string $user_name -- User name to authenticate with
* @param string $password -- MD5 of the user password
* @param string $id -- the id of the record
* @return contact detail array along with associated objects.
*/
function get_contact_relationships($user_name, $password, $id)

2) Get_Contact_Relationships( )

This will return all associated Accounts, Opportunities, Cases, Bugs, Projects

Archive an Email from OPI

Once the user selects one or more emails along with one or more objects to relate that email to, OPI will then make the following calls:

1) for each attachment we will do the following:

/**
* Update or create a single SugarBean.
*
* @param String $session -- Session ID returned by a previous call to login.
* @param String $module_name -- The name of the module to return records from.
This name should be the name the module was developed under (changing a tab
name is studio does not affect the name that should be passed into this
method) . .
* @param Array $name_value_list -- The keys of the array are the SugarBean
attributes, the values of the array are the values the attributes should have.
* @return Array ‘id’ -- the ID of the bean that was written to (−1 on error)
* ‘error’ -- The SOAP error if any.
*/
function set_entry($session, $module_name, $name_value_list){

a) set_entry( )

/**
* Add or replace the attachment on a Note.
*
* @param String $session -- Session ID returned by a previous call to login.
* @param Binary $note -- The file contents of the attachment.
* @return Array ‘id’ -- The ID of the new note or −1 on error
* ‘error’ -- The SOAP error if any.
*/
function set_note_attachment($session,$note)

b) set_note_attachment( )
2) set_entry(session, “Emails”, name_value_list)
3) foreach object we would like to associate this email to:

/**
* Set a single relationship between two beans. The items are related by module
name and id.
*
* @param String $session -- Session ID returned by a previous call to login.
* @param Array $set_relationship_value --
* ‘module1’ -- The name of the module that the primary record is from. This
name should be the name the module was developed under (changing a tab name is
studio does not affect
the name that should be passed into this method) . .
* ‘module1_id’ -- The ID of the bean in the specified module
* ‘module2’ -- The name of the module that the related record is from. This
name should be the name the module was developed under (changing a tab name is
studio does not affect the name that should be passed into this method) . .
* ‘module2_id’ -- The ID of the bean in the specified module
* @return Empty error on success, Error on failure
*/
function set_relationship($session, $set_relationship_value){

a) set_relationship( )
4) foreach note attachment created in step 1:

/**
* Attach a note to another bean. Once you have created a note to store an
* attachment, the note needs to be related to the bean.
*
* @param String $session -- Session ID returned by a previous call to login.
* @param String $note_id -- The ID of the note that you. want to associate with
a bean
* @param String $module_name -- The name of the module to return records from.
This name should be the name the module was developed under (changing a tab
name is studio does not affect the name that should be passed into this
method) . .
* @param String $module_id -- The ID of the bean that you want to associate
the note with
* @return no error for success, error for failure
*/
function relate_note_to_module($session,$note_id, $module_name, $module_id){
a) relate_note_to_module( )

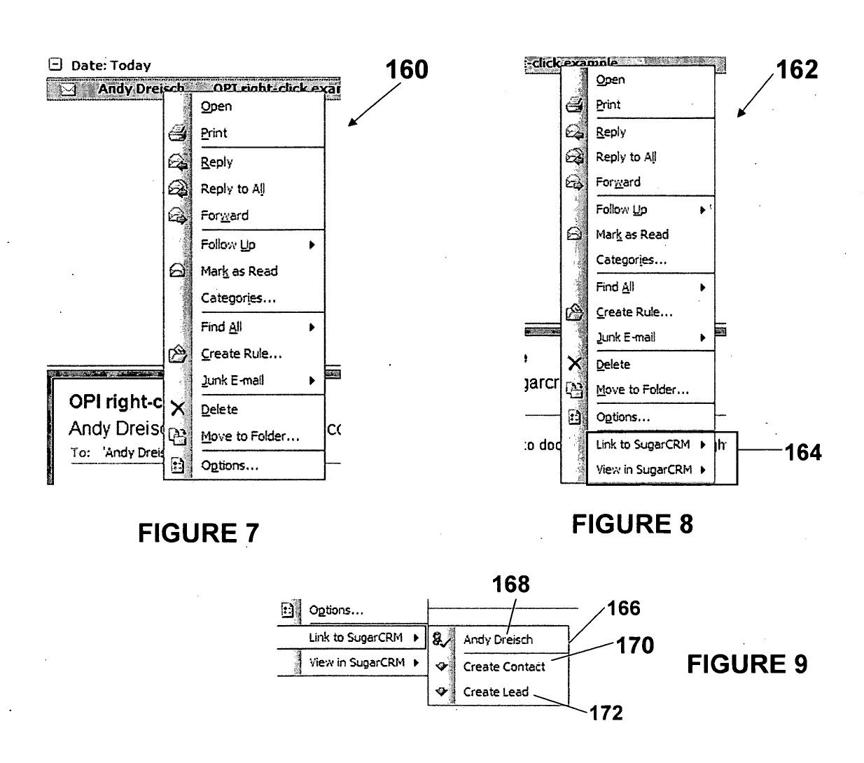

By altering the standard behavior of the email program and making the email program cognizant of data residing elsewhere, such as in the CRM system, the user of the email program plug-in 109 of the system are able to ascertain additional information that the email program alone could not convey. FIG. 7 illustrates a typical option menu 160 that is displayed to the user in the email program when the user performs a right click of the mouse. The menu 160 has the typical menu items as shown. By performing a web service function (look-up) and by tailoring the menu to provide context provided via external systems, the system provides users with an immediately identifiable way to ascertain the presence or absence of related information in the companion CRM system 100. For example, if the From email address matches a CRM system Account, Contact or Lead record (See an exemplary record in FIG. 10), the standard menu will be modified as shown in FIG. 8 to display a modified menu 162.

FIG. 8 shows the modified menu 162 that, due to the presence of information in the CRM system 100, contains new menu items 164. In accordance with the invention, the types of menu items and their functions may change. In this example of the modified menu, the new menu items may include a “Link to SugarCRM” item and a “View in SugarCRM” item. The “View in SugarCRM” menu option provides convenient access to the SugarCRM system, placing the user directly in the relevant screen to allow perusal. In this example, the existence of these two items is predicated on the existence of related CRM record(s) (See FIG. 10) obtained via a web service lookup. In this example the From address contained in the email item matches record(s) located in CRM system via a web service call. With these added menu items, the user is then able to directly associate the email with a CRM record via other web service calls using the “Link to SugarCRM” option. FIG. 9 illustrates more details of the “Link to SugarCRM” menu item that, in this example, provides a link 168 to the person referred to in the email, a create contact link 170 (to create a new contact in the CRM system) and a create lead link 172 (to create a new lead in the CRM system) so that the user, from within the email program, is able to perform CRM system functions such as creating a contact link or creating a lead link. Thus, the system automatically generates and incorporates contextual menu items into the email program so that the email program and the CRM system are more tightly integrated together which simplifies the user's interaction with both systems. Now, a method for integrating web services into a convenient storage metaphor will be described.

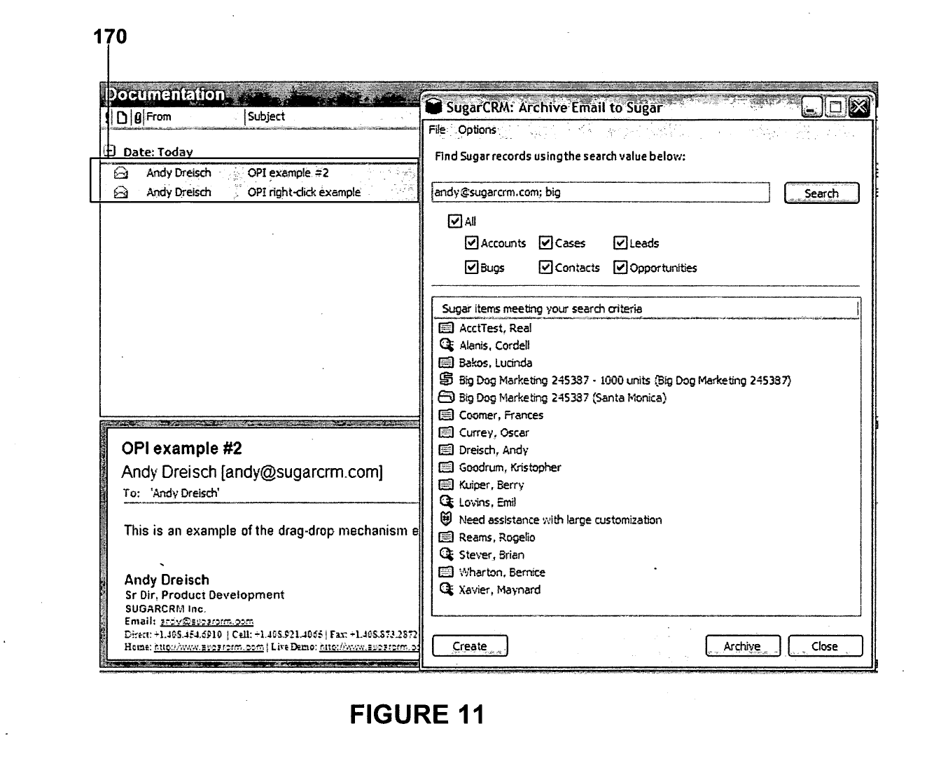

The system 100, and in particular the email plug-in 109, permits the user to quickly and conveniently associate email program email items with external systems via Web services so that the email program and the system 100 are more tightly integrated together for a more robust user experience. As shown in the example in FIG. 11, the system allows the user to quickly archive emails within their corporate system 100, thus providing a complete record of interactions over time. During the archive process, the system automatically transfers some or all of the content to the application system and may also associate the transferred data to the appropriate records in the application system. As shown in FIG. 11, two email items 170 are used as the basis of this example. However, any number of emails may participate in this process. In particular, email addresses contained in the selected email items forms search criteria that is used via Web 'service calls to interrogate the CRM system 100. In the example above the Outlook items' email address for andy@sugarcrm.com matches a CRM record, highlighted in yellow for illustration purposes. A general search, in this case the word ‘big’ can be specified as well and matching records are also displayed. Now that the user has identified all applicable CRM items via Web service queries, it's a simple matter of associating the email(s) with the specific items of interest. This can be done via drag-drop or by selecting appropriate items and clicking the Archive button. In either manner, web service calls are used to archive the emails to the corporate CRM database. Even though this implementation uses web services, any method of connecting to an external system to get and receive information to bring into the email program would suffice. In addition, the above system works for all programs (text editors, documents, files, pictures) and not just the email program example described above. Now, a method for automatically configuring email will be described.

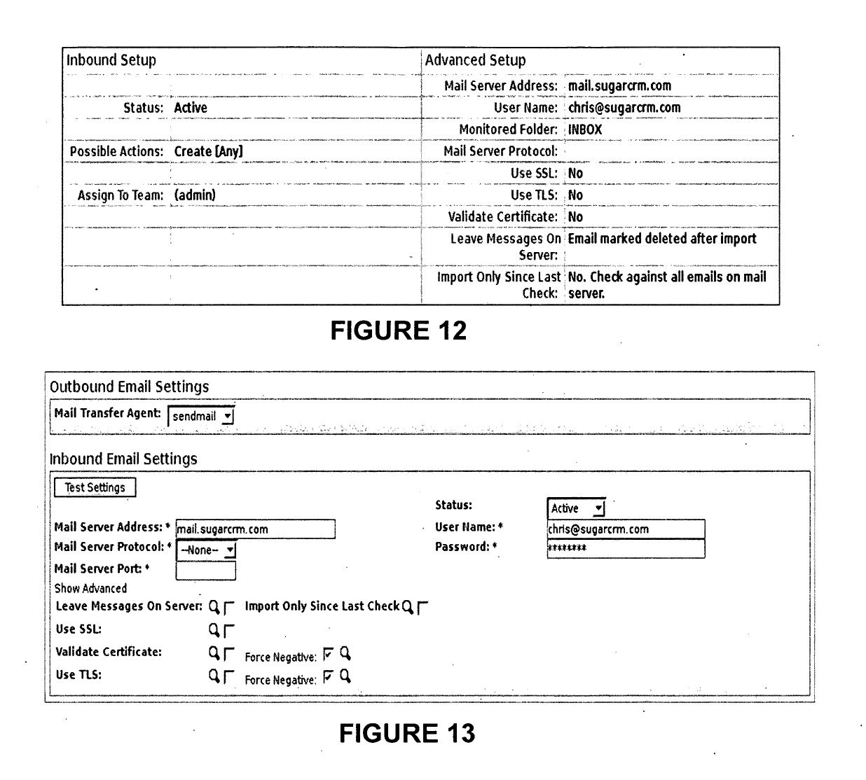

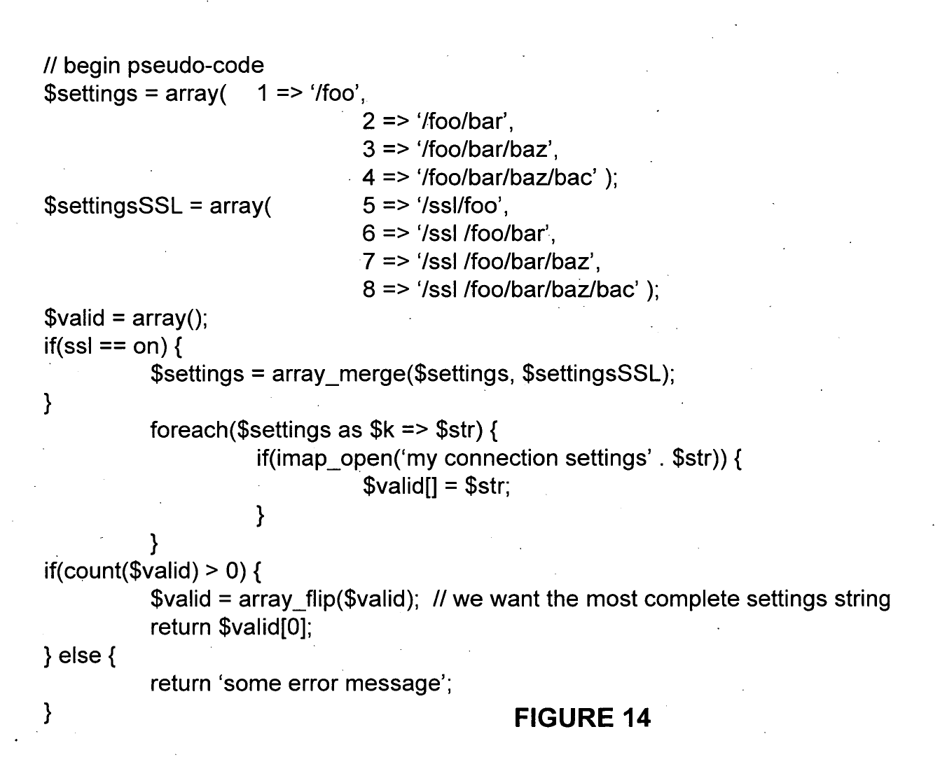

The system 100 incorporates an inbound email auto-configure IMAP or POPs settings for PHP. The InboundEmail utilizes a process to programmatically find and set the best possible combinations of settings when creating an Email account in the CRM system. The main point of this process is PHP's implementation of IMAP and POP3 connectivity does not fail gracefully, and it does not try to reconnect with other variations. This results in many PHP-based email client failures. The system's InboundEmail code tries to determine best-case settings. FIGS. 12 and 13 show examples of the inbound and outbound email settings in the system 100. In the process, once a valid connection string is found, those settings are saved per-account in the InboundEmail table in the database 110. The main logic fork is determined by whether the user has specified an SSL connection (secure socket layer). The code iteratively checks the connection, saving only valid connection parameters. Once found, if there are more than 0 valid parameters, the code will return them to the calling script. If none are found, an error is produced. If the settings are named Foo, Bar, Baz, and Bac and the possible connection types are non-SSL or SSL-enabled, then an example of the pseudo-code of the process is shown in FIG. 14.

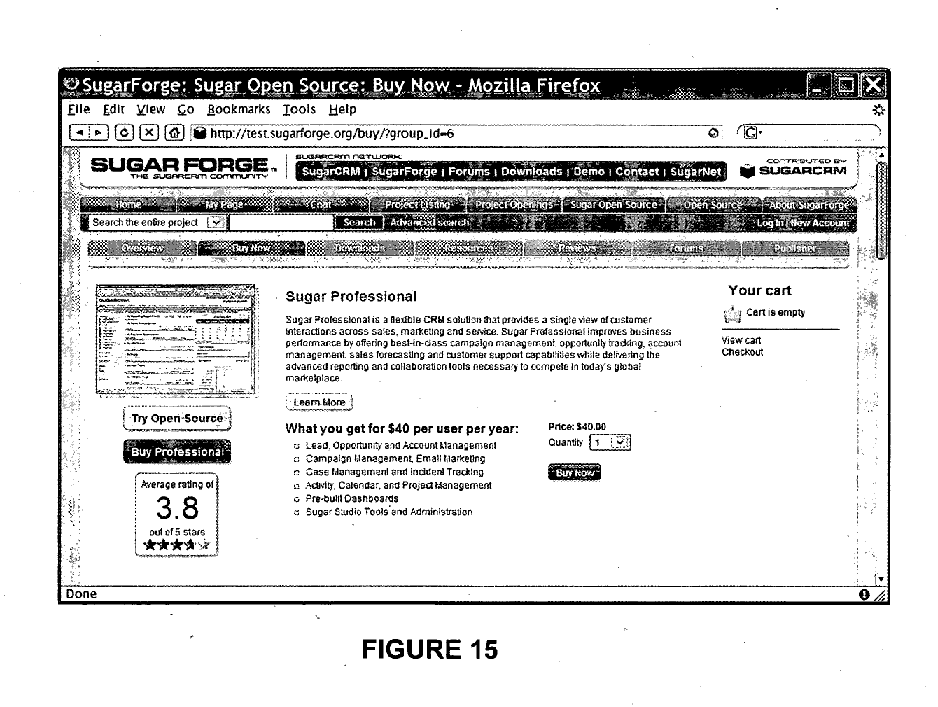

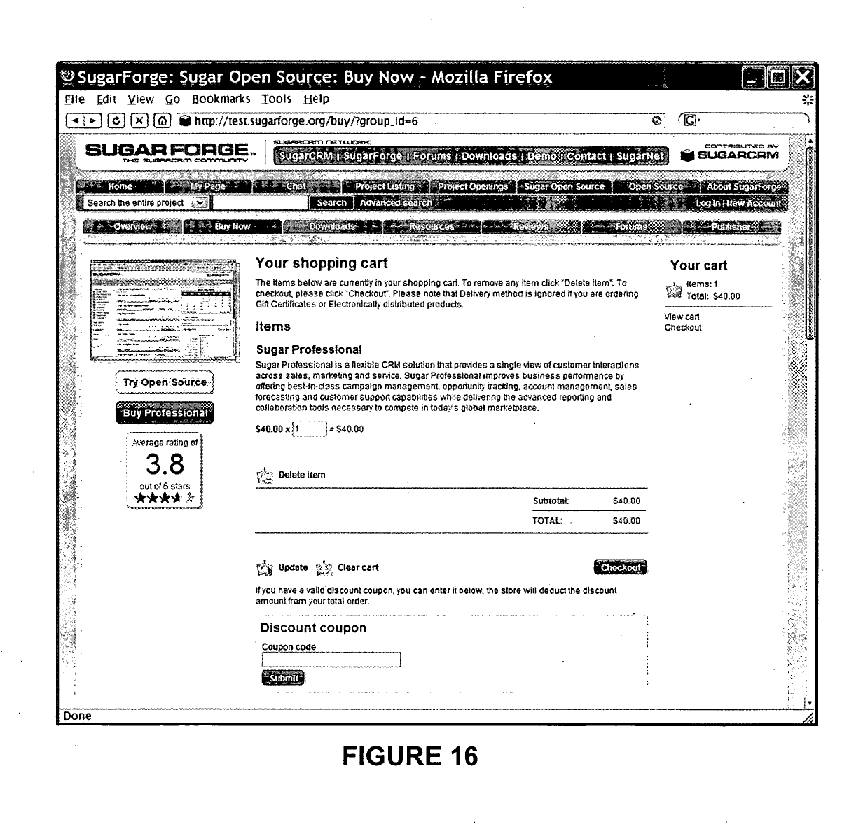

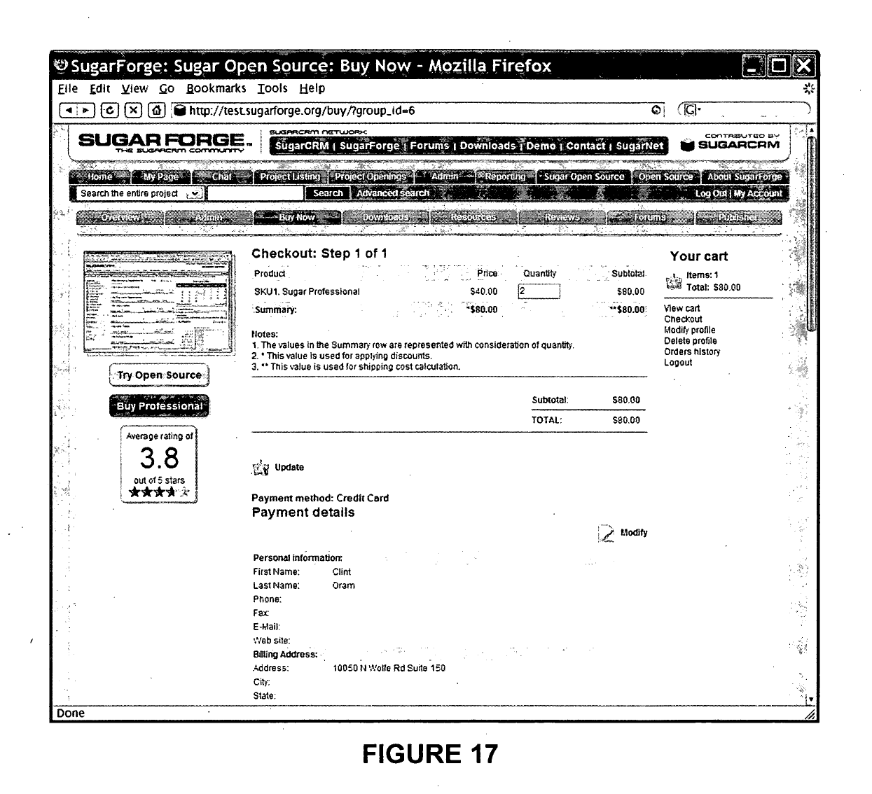

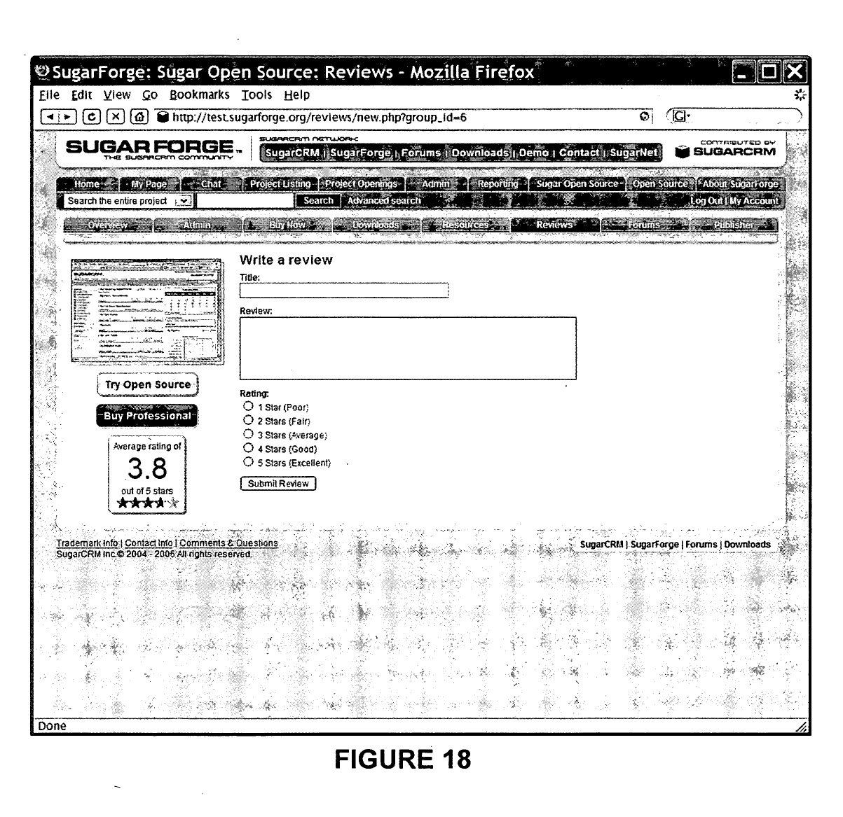

The system may also include ecommerce capability within a site that facilitates collaborative community based software development wherein the site may be internal to a system or external to a system. For example, these sites may be an open source repository site for open source projects, such as Sourceforge.org, SugarForge.org, freshmeat and apache.org. For example, the system 100 shown in FIGS. 1A and 1B may be used with an open source repository site known as SugarForge.org. An example of the user interface for this repository is shown in FIG. 15. The repository includes a unique concept whereby ecommerce capabilities. In particular, within a software project hosted on SugarForge.org (an online Open Source software repository), project administrators can now sell software using a shopping cart feature as shown in FIG. 16. In addition to the shopping cart that permits the user to buy the product, the system may also allow the consumer to click through to the website of the host for purchase. For example, if the user buys a complicated service or product that is not easily described (such as a Dell server), the system provides a link to the partner that is offering that service. Thus, project administrators can choose to distribute the CRM system 100 for free or for a fee from the same SugarForge.org project. An example of the checkout functionality of this aspect of the system is shown in FIG. 17. FIG. 18 an example of a user interface for rating software that provides the collaborative community based software development with a method for project review within the Open Source repository site. Within a software project hosted on SugarForge.org, non-project members can rate a software project and effect the average rating of a project.

Appendix A describes the integration of a SugarNetwork with the CRM system 100. With the integration, the CRM system tracks the login information of each user and allows the user to access the Sugar Network website from within the CRM application (if the user is an administrator). When the user has access to the Sugar Network website, the user can purchase a subscription to the network if the user has not already done so, get to forums, submit cases, view open case status, submit bugs, view open bug status, browser bug databases and the like. Thus, as shown in the first slide, the Sugar Network provides on-line services (company lookup, prospect lists, data quality and user training), plug-ins (additional modules from sugarforge.org and sugarforge.com), support (technical support for all editions of the system including the open source editions), and systems management (backup, failover, migration and maintenance). Slides 2-3 of the presentation show more details of the functionality offered by the sugar network website. Slides 4-7 illustrate examples of the user interface of the sugar network website wherein phase 1 is the current example of the functionality and phase 2 is a future example of the website user interface.

While the foregoing has been with reference to a particular embodiment of the invention, it will be appreciated by those skilled in the art that changes in this embodiment may be made without departing from the principles and spirit of the invention, the scope of which is defined by the appended claims.

1. A computer-based system, comprising:
a client;
an application system having a data source containing a plurality of pieces of information, one or more modules that access the database to pull pieces of information from the database based on a request from the client and display a user interface to the user containing the requested information, one or more controllers that control access by the client to the one or more modules and the data source and a class wherein each module further comprises a subclass of the class; and
the application system further comprising an application programming interface portion that allows the integration of the application system with an application using a web service wherein the application extension further comprises one or more contextual menu items that are associated with the application system.

2. The system of claim 1, wherein the application further comprises an email application integrated with the application system wherein an email address is associated with a user list of the application system using a lookup request to search the data source of the application system for a user in the user list.

3. The system of claim 2, wherein the lookup request further comprises a web service.

4. The system of claim 2, wherein the application system is a customer relationship management system and the class further comprises a sugarbean class.

5. The system of claim 2, wherein the email application further comprises an archive portion that automatically transfers an email message content to the data source of the application system.

6. The system of claim 5, wherein the archive portion automatically associates the email message content with the pieces of data in the data store.

7. A computer-based system, comprising:
a client;
a customer relationship management application system having a database containing a plurality of pieces of information, one or more modules that access the database to pull pieces of information from the database based on a request from the client and display a user interface to the user containing the requested information, one or more controllers that control access by the client to the one or more modules and the database and a class wherein each module further comprises a subclass of the class; and
wherein each module further comprises a set of user interface elements associated with the module and-a drag and drop portion that permits a user to drag and drop the set of user interface elements of the module.

8. The system of claim 7, wherein the user interface elements further comprise at least one of a chart, a sub-panel and a home screen layout.

9. A computer-based system, comprising:
a client;
an application system having a database containing a plurality of pieces of information, one or more modules that access the database to pull pieces of information from the database based on a request from the client and display a user interface to the user containing the requested information, one or more controllers that control access by the client to the one or more modules and the database and a class wherein each module further comprises a subclass of the class; and
a PHP email application that is automatically configured to determine a set of settings for the email connectivity.

10. The system of claim 9, wherein the PHP email application further comprises a piece of code that determines a valid email connection parameter.

11. The system of claim 10, wherein the PHP email application further comprises a piece of code that tries a set of connection parameters to determine a best connection parameter.

12. A computer-based system, comprising:
a collaborative community based software development system having a plurality of software applications stored therein; and
an ecommerce portion that permits a sale of at least one of the plurality of software applications to occur.

13. The system of claim 12, wherein the collaborative community based software development system further comprises an open source software repository having a plurality of open source software applications stored therein.

14. The system of claim 12, wherein the ecommerce portion further comprises a checkout feature.

15. The system of claim 12, wherein the ecommerce portion further comprises a ratings feature.

16. A computer-based system, comprising:
a client;
an application system having a database containing a plurality of pieces of information, one or more modules that access the database to pull pieces of information from the database based on a request from the client and display a user interface to the user containing the requested information, one or more controllers that control access by the client to the one or more modules and the database and a class wherein each module further comprises a subclass of the class; and
a network system associated with the application system, wherein a user of the application system can access the network system within the application system and wherein the network system provides one or more online services to the user of the application system.
